(19) United States
(12) Patent Application Publication
(10) Pub. No.: US 2002/0173946 A1
(43) Pub. Date: Nov. 21, 2002

(54) Translation and communication of a digital message using a pivot language

(76) Inventor: Samuel T. Christy, North Cambridge, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/820,153

(22) Filed: Mar. 28, 2001

(51) Int. Cl. G06F 17/28

(52) U.S. Cl. 704/2

(57) ABSTRACT

A method and apparatus for facilitating the translation of a digital message between natural languages utilizes a pivot language as an intermediate representation of the original natural language. Conversion of the digital message from the original natural language into the pivot language may include parsing into linguistic units, translating into unique concepts, and validating the translation. The digital message may be electronically communicated to a recipient in a pivot language for subsequent translation or in the target natural language after translation. The digital message may take the form of electronic mail or an instant message. An applet that initiates translation to the target natural language may be attached to the digital message. The apparatus may include a conversion module for translating from a natural language to a pivot language and a communication module. The apparatus may additionally include a speech recognition module and/or a speech synthesis module.

### BACKGROUND OF THE INVENTION

The 20th century has seen remarkable breakthroughs in communication technologies that have advanced the globalization of information. Communication is now possible in virtually any part of the world using devices capable of receiving and transmitting information through wire or wireless mediums. Even the field of telephony has advanced to the point where landlines are not always needed.

Through the Internet, information can be conveniently and expeditiously exchanged throughout the globe. Because it enables digital messages to be transmitted back and forth almost instantaneously among users at very little cost, the Internet has become an integral part of modem communication.

One popular form of communication is electronic mail (e-mail). Typically, a user connected to a network transmits e-mail by sending it to an e-mail server that services the intended recipient. On receipt, the e-mail server stores the e-mail in individual electronic mailboxes until its recipient accesses the server. The server then makes available the e-mail for his disposal.

Another form of communication, similar to e-mail but faster, is instant messaging. Typically, a sender connected to a network checks for the on-line presence of the intended recipient. If the intended recipient is present on-line, the sender can send an instant message to an instant message service for delivery to an instant inbox. The instant messaging server displays the message on the display then associated with the instant inbox of its intended recipient. Instant messaging is now typically implemented on a local area network (LAN).

However, in the age where communication can occur globally, the language barrier has proven to be an obstacle to the rich interchange of information. Translation has historically been more of an art than a science. Even the best human translators can disagree on the proper translation of a text. Accordingly, reliable translation has required intimate knowledge and human interpretation of both the source language and the target language.

Available methods and apparatuses for automated translation from a source natural language to a target natural language have not produced satisfactory results. The translation produced by the available methods and apparatuses is often seriously flawed. The flaws derive from subtle difficulties of translation that available methods and apparatuses do not address, such as the lack of one-to-one correspondence among languages, the existence of homonyms, and the idiosyncrasies of grammar.

Consider a joint research project involving multiple corporations and universities in different countries. A university in China may need to communicate with a university in Russia concerning the status of software being jointly developed for the project. Sponsoring corporations in Japan and the United States may need to evaluate university-generated status reports and communicate regarding continued finance and overall progress. Because each country has its own native languages, opportunities for miscommunication and communication breakdowns abound.

Moreover, the language barrier may impose difficulties of a purely technical nature. For example, the Chinese text of a digital message may not be supported by a personal computer (PC) configured in Russian. Similarly, the Japanese text of a digital message may not be supported by the PC configured in English. Typically, what the recipient will see is a gabbled mess. While English has somewhat taken on the role as the “universal language,” the majority of the world population is not able to read or write English. Typically, mastering another language is a strenuous effort requiring years of discipline and education, deterring most people from making the effort.

### SUMMARY OF THE INVENTION

In one aspect, a method of facilitating the translation of a digital message between natural languages utilizes a pivot language as an intermediate representation. The message is expressed in a pivot language and electronically communicated to a recipient for subsequent translation. The conversion of the digital message from the natural language into the pivot language may include several steps. The digital message in the natural language may first be parsed into linguistic units to create a parsed message. Each of the linguistic units may then be translated into a unique concept in the pivot language, and if the resulting provisional message conforms to the pivot language, validated. After validation, the digital message in the pivot language is communicated to the recipient.

Variations of the foregoing method are possible. The conversion of the digital message to the pivot language may further include resolving the provisional message according to the rules of a constrained grammar. The conversion may further include “disambiguation,” i.e., prompting the originator to select a unique concept from the pivot language when the linguistic unit is associated with more than one unique concept in the pivot language. Disambiguation may occur while the originator is composing the digital message or after it is complete. Messages amenable to translation and transmission in accordance with the invention may take many forms. For example, the digital message in the pivot language may be communicated to the recipient as an instant message or as a piece of electronic mail. An applet that initiates translation may be communicated to the recipient with the digital message. Such an applet could be a link included with the piece of electronic mail. Indeed, even spoken messages may be translated. For example, speech recognition may be used to convert the sound of a human voice into a digital message in a natural language. Finally, the digital message may be communicated directly to a module for translation.

In another aspect, an apparatus for facilitating the translation of a digital message between natural languages may comprise a conversion module and a communication device. The conversion module may convert the digital message from a natural language into a pivot language using a parsing module, a translation module, and a validation module. The parsing module may parse the digital message in the natural language into linguistic units. The translation module may access a database to translate each of the linguistic units into a unique concept in the pivot language to create a provisional message. The validation module may validate the provisional message if it conforms to the pivot language. After validation, the communication device may communicate the digital message in the pivot language to a recipient.

Variations of the foregoing apparatus may include further resolving the provisional message according to the rules of a constrained grammar. The conversion module may further include a disambiguation module that prompts an originator to select the appropriate concept from the pivot language when the linguistic unit corresponds to more than one unique concept in the pivot language. The conversion module may allow the originator to select whether disambiguation will occur while he is composing the message or later. The apparatus itself may include a speech recognition module that converts the sound of a human voice into a digital message in a natural language. The apparatus may allow the originator to designate the recipient. For example, the originator may select that the message be transmitted directly to a translation module. The apparatus may also allow the originator or the recipient to designate the form in which the digital messages in the pivot language is communicated. For example, the recipient may select that the message be communicated as an instant message or as a piece of electronic mail.

In a third aspect, the invention facilitates conversion of a digital message expressed in a pivot language into a digital message in a target natural language, which is then communicated to a recipient. The translation of the digital message from the pivot language into the natural language may include several steps. A natural language associated with the recipient may be identified. A database associated with the natural language may be accessed, and the digital message in the pivot language may be translated into the natural language using the database. After translation, the digital message in the natural language may be communicated to the recipient.

Variations of the foregoing method are again possible. For example, the method may further comprise receiving a selection of a target natural language to associate with the recipient. Translation may be accomplished by directly substituting a linguistic unit in the digital message in the pivot language with an equivalent linguistic unit from the database associated with the target natural language. The conversion of the digital message to the natural language may further include reorganizing the linguistic units according to grammatical rules associated with the natural language. Again, messages amenable to translation in accordance with the invention may take many forms, such as an instant message or a piece of electronic mail. Similarly, the digital message in the target natural language may be communicated to the recipient in a mode selected by the recipient or the originator. For example, the method may further comprise synthesizing the sound of a human voice speaking the digital message in the target natural language. Alternatively, the digital message in the target natural language may be sent to the recipient as electronic mail or an instant message. Finally, the conversion may be initiated by the execution of an applet, which may be associated with the digital message in the pivot language.

In yet another aspect, an apparatus for facilitated translation of a digital message into a natural language may comprise a conversion module and a communication device. The conversion module is responsive to a natural language associated with a recipient and converts a digital message in a pivot language into a digital message in a natural language. The conversion module may further comprise a database accessor and a translation module. The database accessor may access a database associated with the natural language, and the translation module may translate the digital message in the pivot language into the digital message in the natural language using the database. The communication device may then communicate the digital message in the natural language to the recipient. The apparatus may further comprise an index that enables a linguistic unit representing a unique concept in the natural language to be directly substituted for a linguistic unit representing a unique concept in the pivot language. The apparatus may further reorganize the linguistic units to conform to one or more grammatical rules associated with the target natural language. The apparatus may further comprise a voice synthesizer that allows the recipient to hear the message in the natural language. Other variations on the apparatus will be evident from the foregoing and the detailed description.

### BRIEF DESCRIPTION OF THE DRAWINGS

In the drawings, emphasis is generally being placed upon illustrating the principles of the invention. The invention description below refers to the accompanying drawings, of which:

FIG. 1 schematically illustrates the application of constrained grammar rules to combine linguistic units and create complex sentences with a basic sentence structure;

FIG. 2 is a schematic representation of a database system embodying the invention;

FIG. 3 is a functional block diagram of an embodiment of the process of creating a digital message in a pivot language and communicating it to a recipient, performed in accordance with the invention;

FIG. 4 is a functional block diagram of an embodiment of the process of creating a digital message in a target natural language and communicating it to a recipient, performed in accordance with the invention;

FIG. 5 is a schematic representation of a Local Area Network (LAN) in which the invention may be implemented;

FIG. 6 is a schematic representation of a Wide Area Network (WAN) or the Internet in which the invention may be implemented;

FIG. 7 is a schematic representation of an electronic mail (e-mail) server;

FIG. 8 is a schematic representation of an instant message service server;

FIGS. 9-18 are flowcharts representing various implementations of the invention;

FIG. 19 is a system comprising an e-mail module and an editor in accordance with an embodiment of the invention;

FIG. 20 is a schematic representation of a hardware system embodying the invention;

FIG. 21 is a system comprising a conversion module for converting a digital message in a pivot language into a target natural language in accordance with an embodiment of the invention; and

FIG. 22 is a schematic representation of a hardware system embodying the invention.

### DETAILED DESCRIPTION OF AN ILLUSTRATIVE EMBODIMENT

In brief, the present invention relates to a system and method for conversion of a digital message from a natural language to a pivot language and for conversion of a digital message from a pivot language to a natural language. A pivot language is an intermediate system of linguistic representation that has been optimized for machine translation, and which facilitates automated language conversion without loss of meaning.

### PIVOT LANGUAGE

A pivot language is designed to surmount the subtle complexities of translation. It serves to as an interface between natural languages. A first natural language is unlikely to have one-to-one correspondence with a second natural language. A pivot language, on the other hand, is designed to have a one-to-one correspondence with multiple natural languages. A pivot language can serve to specify the meaning of a homonym in the source natural language prior to translation into a target natural language. A pivot language can also address the idiosyncrasies of grammar associated with a natural language. Accordingly, the function of a pivot language is to resolve meaning prior to translation to ensure that the proper meaning is conveyed in the translation.

An example of a pivot language is a constrained grammar, which is derived from the user's native language and may be defined in terms of lexical rules or a structured vocabulary. A constrained grammar defined by lexical rules requires adherence to a finite set of rules for sentence formation but allows the expression of thoughts and information ordinarily conveyed in a natural grammar. A constrained grammar defined by structured vocabulary requires that thoughts and information be expressed with a finite lexicon that may be divided into linguistic units and formed into a finite number of classes. Since a pivot language based on a constrained grammar is merely a more highly structured version of the natural language, resolving a digital message in a natural language into the pivot language is straightforward. The purpose of constrained grammar is to facilitate easy translation—preferably by simple word substitution from one language database into another.

U.S. Pat. No. 5,884,247, entitled “Method and Apparatus for Automated Language Translation,” (hereby incorporated by reference and herein referred to as the '247 patent) describes an example of a pivot language. The '247 patent describes a pivot language based on a constrained grammar amenable to automated translation. The allowed sentence types are diverse enough to permit expression of sophisticated concepts. Since sentences are also derived from vocabulary that is organized according to fixed rules, they can be readily translated from one language to another. In one embodiment, the vocabulary is represented in a series of physically or logically distinct databases, each containing entries representing a class defined in the grammar. Translation involves direct lookup between the entries of a source sentence and the corresponding entries in one or more target natural languages. Further specifics of the entries will now be described.

Each database entry associated with a particular lexicon may be a linguistic unit. A linguistic unit may represent a unique concept; and the concept may be further represented by a word-concept. A word-concept in many instances may perform like a word; however, it may have features not normally found in a word. For example, the concept of a “doctor who is serving a residency” may be represented by a word-concept “medical-resident.” However, this term may not be listed as a defined word or term in the various English dictionaries. Generally, a feature of a word-concept is the concept it represents and not simply the characters that represent the word-concept. For instance, the word-concept that represents the concept “flow of water from the ground” is “spring”. The word-concept that represents the concept “a season after winter and before summer” is also “spring.” While the two word-concepts have the same spelling, the editor recognizes that each of the word-concepts is associated with a different unique concept. According to one embodiment, the database stores each concept and the associated word-concept under a unique keynumber and distinguishes the two concepts using the keynumbers. A format of the word-concept may be (1) a single word, such as “dog” or “government”; or (2) a hyphenated combination of words, such as “parking-space” or “prime-minister”; or (3) characters with a unique definition, such as an alias.

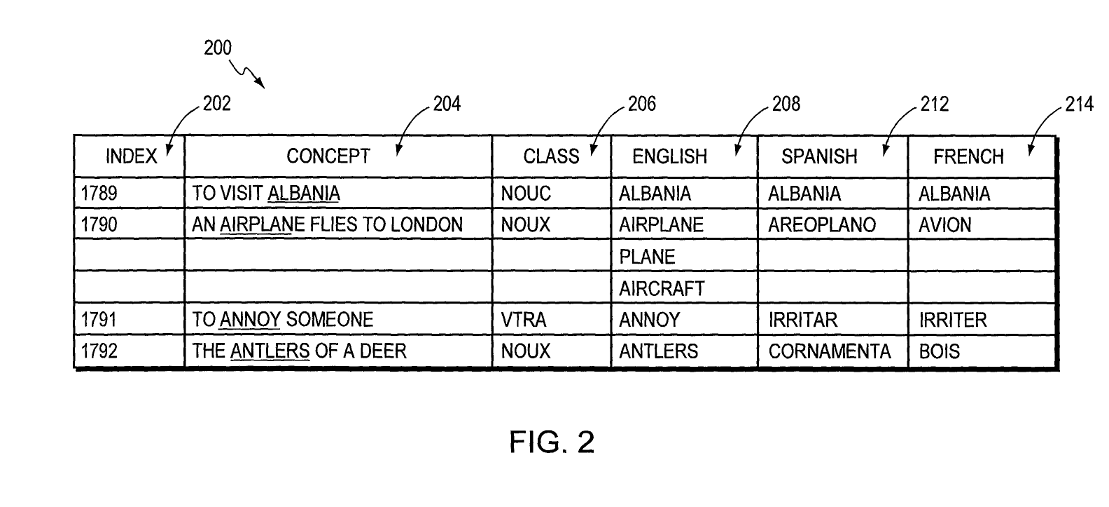

FIG. 2 illustrates how an index of unique concepts may be used to facilitate translation. Each unique concept in FIG. 2 is associated with a unique keynumber. In the context of a translation system, the word-concepts are particular to a language database. For example, a homonym has multiple meanings, each of which will correspond to a different concept. Accordingly, each meaning associated with a homonym may be denoted by the same word-concept but indexed by a separate keynumber. The keynumbers allow the editor to distinguish the different concepts. Synonyms, in contrast, are words that share the same meaning. Accordingly, for synonyms, different word-concepts may be associated with the same concept and indexed by the same keynumber. Alternatively, each synonymous word-concept may be a separate concept entry in the database, with all of the synonymous concepts linked by the use of the same keynumber. For example, consider the words “steal” and “take.” The word-concept “steal” may represent the concept “to steal something from someone” and the word-concept “take” may link to the concept “to steal something from someone” in the database. FIG. 2 illustrates that a single concept “An airplane flies to London” can be linked with word-concepts “airplane”, “plane” and “aircraft”.

Linguistic units may be organized into classes. For example, a lexicon of linguistic units may be divided into four classes. The four classes of a constrained grammar may be:

(1) “things” (hereinafter identified by T and know as nominal terms), defined as linguistic units that connote, for example, people, places, items, activities or ideas;

(2) “connectors” (hereinafter identified by C) defined as linguistic units that specify relationships between two or more nominal terms;

(3) “descriptors” (hereinafter identified by D) defined as linguistic units that modify the state of one or more nominal terms; and

(4) “logical connectors” (hereinafter identified by C defined as linguistic units that establish sets of the nominal terms.

Connectors include words typically described as prepositions and conjunctions, and terms describing relationships in terms of action, being, or states of being. Descriptors include words typically described as adjectives, adverbs and intransitive verbs. The preferred logical connectors are “and” and “or.” Exemplary constrained lists of nominal terms, connectors and descriptors are set forth in the '247 patent.

Simple sentences are groups of linguistic units from the lexicon combined in accordance with a basic structure. Each basic structure represents the smallest possible sets of linguistic units required to carry information; each basic structure can be the foundation for a more complex sentence. The structural simplicity of a basic structure facilitates ready translation into conversational, natural language sentences. Basic Structure 1 (BS1) is a nominal term followed by a descriptor; the structure is described by the designation TD. The BS1 sentence “Bill swim” readily translates into the English sentence “Bill swims.” The BS1 sentence “dog brown” readily translates into the English sentence “the dog is brown.” Basic Structure 2 (BS2) is a connector between two nominal terms; the structure is described by the designation TCT. The BS2 sentence “dog eat food”, like other BS2 sentences, readily translates into an English equivalent.

Complex sentences are groups of linguistic units from the lexicon combined in accordance with one of the basic structures and one or more of the following rules.

Rule I: A descriptor can be added to a nominal term (T→TD). In accordance with Rule I, any linguistic unit from the nominal class can be expanded into the original item followed by a new item from the descriptor class, which modifies the original item. For example, “dog” becomes “dog big.” Like all rules of constrained grammar, Rule I is not limited in its application to an isolated nominal term (although this is how BS 1 sentences are formed). Instead, Rule I can be applied to any nominal term regardless of location within a larger sentence. Thus, in accordance with Rule I, TD₁→(TD₂)D₁. For example, “dog big” becomes “(dog brown) big,” a pivot language sentence that corresponds to the English sentence, “The brown dog is big.”

The order of addition of consecutive adjectives may or may not be important since they independently modify T; for example, in “(dog big) brown,” the adjective “big” distinguishes this dog from other dogs, and “brown” may describe a feature thought to be otherwise unknown to the listener. The order of addition is usually important where a D term is an intransitive verb. For example, expanding the TD sentence “dog run” (corresponding to “the dog runs” or “the running dog”) by addition of the descriptor “fast” forms, in accordance with Rule I, “(dog fast) run” (corresponding to “the fast dog runs”). To express “the dog runs fast,” it is necessary to expand the TD sentence “dog fast” with the descriptor “run” in the form “(dog run) fast.”

Applying Rule I to expand BS2 can produce the following more complex sentence structure: TCT→(TD)CT. For example, “dog eat food” becomes “(dog big) eat food.” Rule I can also be applied to compound nominal terms of the form TCT, so that a structure of form TCT becomes TCT→(TCT)D. For example, “mother and father” becomes “(mother and father) drive.” In this way, multiple nominal terms can be combined, either conjunctively or alternatively, for purposes of modification. It should also be noted that verbs having transitive senses, such as “drive,” are included in the database as connectors as well as descriptors. Another example is the verb “capsize,” which can be intransitive (“boat capsize”) as well as transitive (“captain capsize boat”).

Rule IIa: A nominal term can be added to another nominal term with a connector (T→TCT). In accordance with Rule IIa, any linguistic unit from the nominal class can be replaced with a connector surrounded by two nominal entries, one of which is the original linguistic unit. For example, “house” becomes “house on hill.” Applying Rule Ia to expand BS1 produces TD→(TCT)D. For example, “gloomy house” becomes “(house on hill) gloomy,” or “the house on the hill is gloomy.” Rule Ia can be used to add a transitive verb and its object. For example, the compound term “mother and father” can be expanded to “(mother and father) drive car.”

Rule IIb: A nominal term can be added to another nominal term with a logical connector (T→TCT). In accordance with Rule IIb, any linguistic unit from the nominal class can be replaced with a connector surrounded by two nominal entries, one of which is the original linguistic unit. For example, “dog” becomes “dog and cat.” In sum, applying either Rule Ia or Rule IIb, a nominal term can be a composite consisting of two or more nominal terms joined by a connector. For example, the expansion “(john and bill) go-to market” satisfies Rule Ia. Subsequently applying Rule I, this sentence can be further expanded to “(john and bill) go-to market) together.

Rule III: A descriptor can be added to another descriptor with a logical connector (D→DCD). In accordance with Rule III, a descriptor can be replaced with a logical connector surrounded by two descriptors, one of which is the original. For example, “big” becomes “big and brown.” Applying Rule III to expand BS 1 produces the following more complex sentence structure: TD→T(DCD). For example, “dog big” (equivalent to “the dog is big,” or “the big dog”) becomes “dog (big and brown)” (equivalent to “the dog is big and brown” or “the big brown dog”).

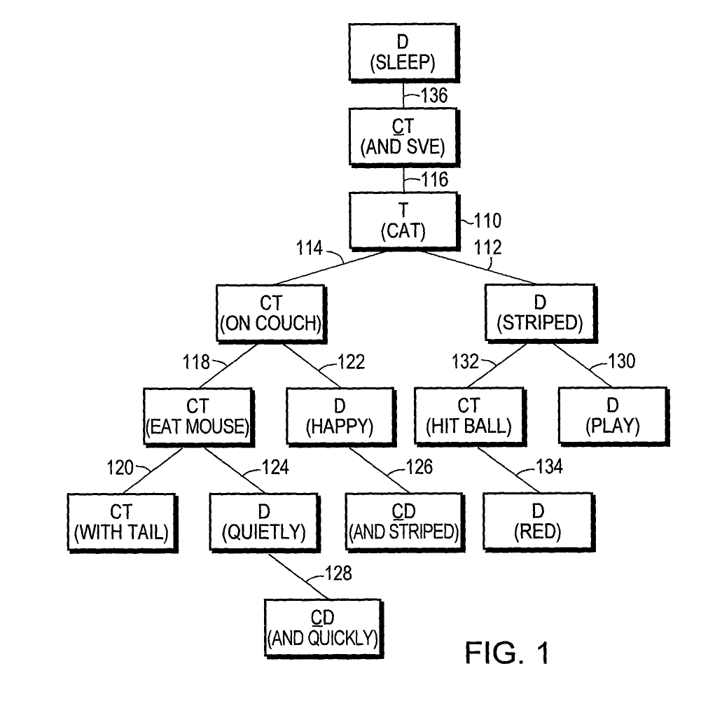

FIG. 1 illustrates three possible applications of the Rules to form sentences that, although complex, comply with one of the basic structures. The nominal term cat, shown at 110 in FIG. 1, is combined with other linguistic units in conformity with the three rules. For example, Rule IIb is applied at 116 in FIG. 1 to produce “cat and Sue.” Rule I can then be used to modify (in the broad sense of the invention) the compound subject formed by Rule IIb, as shown at 136, and produce a sentence (BS1).

Rule I is applied at 112 in FIG. 1 to produce “cat striped” (BS1). Rule I can be applied iteratively as shown at 112 and 130 to further modify the original T (although, as emphasized at 130, a descriptor need not be an adjective). Rule Ia is available to show action of the modified T (as shown at 132), and Rule I can be used to modify the newly introduced T (as shown at 134).

Rule IIa is applied at 114 in FIG. 1 to produce “cat on couch” (BS2). Rule IIa is again applied at 118 to produce a sentence structure of the form TC₁T₁→(TC₁T₁)C₂T₂ or “((cat on couch) eat mouse)”. A third application of Rule IIa at 120 produces a sentence structure of the form (TC₁T₁)C₂T₂→((TC₁T₁)C₂T₂)C₃T₃ or “(((cat on couch) eat mouse) with tail).” Rule I can be applied at any point to a T linguistic unit as shown at 122 (to modify the original T, cat, to produce “(happy cat) on couch”) and 124 (to modify “eat mouse”). Rule III can also be applied as shown at 126 (to further modify cat to produce “(((happy and striped) cat) on couch)”) and 128 (to further modify “eat mouse”).

The order in which linguistic units are assembled can strongly affect meaning. For example, the expansion TC₁T₁→(TC₁T₁)C₂T₂ can take multiple forms. The construct “cat hit (ball on couch)” conveys a meaning different from “cat hit ball (on couch).” In the first arrangement, the ball is definitely on the couch; whereas, in the second arrangement, the action is taking place on the couch. The sentence “(john want car) fast” indicates that the action should be accomplished quickly, while “(john want (car fast))” means that the car should move quickly.

Alternatively, the constrained grammar of a pivot language may be defined in terms of “allowed sentence structures” (rather than in terms of combination rules capable of generating a virtually limitless number of sentence types). In accordance with an application entitled “Language Translation Using a Constrained Grammar in the Form of Structured Sentences”, filed on Sep. 24, 1999, and assigned Ser. No. 09/405,515 (hereby incorporated by reference and hereinafter referred to as the '515 application), the classes of linguistic units may be expanded into subclasses and the allowed sentence formats may be characterized in terms of the subclasses.

The use of allowed sentence-structure “templates” allows for provision of language-specific terms and/or modifications that are required by the nature of the construction, rather than its linguistic content. For example, the system may utilize internal and external representations of the structures:

| Internal Rep. | English Rep. | Japanese Rep. | | |
|---|---|---|---|---|
| NC VTRA NC | She buys bread | Kanoja wa | pan o | kaimashita |
| | | She | bread | buys |
| | NC VTRA NC | NC (wa) | NC (o) | VTRA |

For each sentence structure there is a single set of rules for each language that dictates the manner in which sentences are translated into and out of the internal structure. In the Japanese representation, “Wa” represents a subject marker and “o” represents a subject marker. Accordingly, the Japanese sentence structure NC (wa) NC (o) VTRA is the only form that directly corresponds to the internal structure NC VTRA NC. Similarly, the English sentence structure NC VTRA NC is the only form that directly corresponds to the internal structure NC VTRA NC. In either case, translation is still accomplished in the internal structure by direct word substitution. Reorganization of the internal structure of a sentence according to sentence structure rules associated with a target natural language is a step that may be part of the process of converting from a pivot language to the target natural language. It represents a form of processing which, though language-specific, is nonetheless executed in the same way for all languages. To rephrase, because this processing is dictated by sentence structure rather than meaning, the mechanics of its application do not vary among languages. Instead, the conversion module simply consults and implements the rules associated with a given sentence structure and language.

Whether sentences are generated in accordance with rules or required to conform to allowed sentence structures, the goal is the same: to ensure substitution at the linguistic unit level will produce an acceptable sentence in any supported language.

### CREATION OF DIGITAL MESSAGE IN PIVOT LANGUAGE

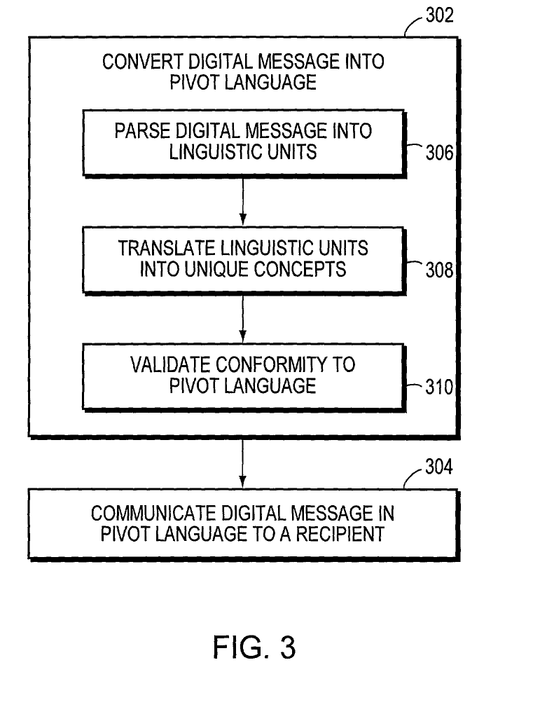

FIG. 3 describes the process of converting a digital message in a source natural language into a pivot language and communicating the digital message in the pivot language to a recipient, in accordance with one embodiment of the invention. The function of the process described by FIG. 3 is to facilitate later translation of a digital message to a different natural language.

The first step in the illustrated process is to convert a digital message in a natural language into a digital message in a pivot language (STEP 302). The characteristics of the selected pivot language affect the manner in which the conversion is performed, since a digital message in a natural language can be converted into a digital message in a pivot language in a variety of ways. In general, STEP 302 is accomplished by performing a series of intermediate steps. In apparatus which implements the process described by FIG. 3, the conversion module may be contained on a single computational processor. Alternatively, the conversion module may comprise several smaller modules each of which perform an intermediate step in the conversion process. These smaller modules may be distributed on multiple computational processors that are connected by a communications system.

The first step in conversion process is to parse the digital message in the natural language into linguistic units (STEP 306). The parsing may be appropriate to the natural language. For example, English sentences may designate the end of a sentence with a period and separate words by spaces. Accordingly, periods may be used to parse a digital message in English into sentences and spaces may be used to parse the sentences into words.

The second step in conversion process is to translate the linguistic units into unique concepts (STEP 308). In some cases, translation of a linguistic unit from a natural language into an equivalent linguist unit in a pivot language is simple. In other cases, there may be multiple potentially equivalent linguistic units in the pivot language for an individual natural language sentence, phrase, or word. These sentences, phrases, or words may be rejected for ambiguity. Similarly, a digital message containing such a sentence, phrase, or word may be returned to the originator as inappropriate for conversion to the pivot language. In such a case, the problem sentence, phrase, or word may be communicated to the originator. Alternatively, these sentences, phrases, or words may be converted to the most likely equivalent based on context or probability. In another alternative, the originator of the natural language sentence, phrase, or word may be prompted to choose among possible natural language meanings with a single equivalent in the pivot language. The selection of the intended meaning from among a plurality of possible meanings is known as disambiguation.

For example, in one embodiment, conversion from a natural language to a pivot language is accomplished in conjunction with an editor. A module may prompt the originator to disambiguate words, phrases and/or sentences into single semantic meanings and to place them in a format suitable for machine translation. The module may either be an add-on to an existing editor or a component of an editor created specifically to facilitate translation. The module may include disambiguation tools designed around the attributes of a specific pivot language. When a user generates text, different tools may search the text for ambiguities at the word-concept, phrase, and sentence level. An example of an editor that includes disambiguation tools is disclosed in an application entitled “Lexical Disambiguation for Translation and Searching,” filed on Dec. 7, 1999 and assigned Ser. No. 09/457,050 (the disclosure which is hereby incorporated by reference and hereinafter referred to as the '050 application).

The opportunity to disambiguate meaning may be presented to the originator while the originator is composing an original digital message in a natural language or later. The originator may be given the opportunity to decide whether the disambiguation editing is to be performed pre-process (i.e., while the originator enters the message) or post-process (i.e., after the originator enters the message). In pre-process mode, the editor interacts with the originator directly as he enters message. For example, if the originator types “labor” the editor may present the originator with the choices “labor in a company” or “labor of giving birth.” The originator may make the selection in real time and then continue entering the text. In post-process mode, the editor interacts with the originator after entry has been completed or when a request is made to the editor. The editor then examines and begins to disambiguate the text through interaction with the originator.

The preferred method of display during disambiguation is a conventional drop-down box that lists a series of concepts for a detected ambiguous word-concept, preferably highlighting the first concept on the list. If the originator does nothing but continue to type, then the highlighted concept will be chosen as the meaning ascribed to the word-concept. For example, if the originator types “scale” in the text, the editor may provide a drop down box with “scale of a fish” and “scale for weighing objects” as concepts. If “scale of a fish” is the first highlighted concept on the list and the user continues to type without selecting another concept, then that concept is automatically selected for the word-concept. This “few keystrokes” feature is advantageous where the editor is able to predict the concept of the word-concept consistently. Other examples of concept list hierarchy may be found in the '050 application.

The third step in conversion process is to validate conformity of the digital message with a pivot language (STEP 310). The validation is appropriate to the selected pivot language. For example, in one embodiment, the arrangement of the linguistic units in the pivot language is compared with a set of allowed sentence structures. If the arrangement of the sentence complies with an allowed sentence structure, the sentence is validated as equivalent sentence in a pivot language based on constrained grammar.

In a second embodiment, modular analysis of the linguistic units in a natural language sentence is used to resolve the natural language sentence into an equivalent sentence in a pivot language based on constrained grammar. Here the rules of expansion from the most basic sentence structures can used to resolve the equivalent linguistic unit in the pivot language. Where the arrangement of linguistic units can be characterized such that their arrangement complies with the rules of the constrained grammar, the sentence is validated as equivalent sentence in a pivot language based on constrained grammar. STEP 310 can be performed simultaneously with STEP 308.

The second step in the process described by FIG. 3 is to communicate the digital message in a pivot language to a recipient (STEP 304). The communication can be accomplished by taking advantage of an existing method of communication within a specific infrastructure, such as using an existing e-mail system associated with the Internet. Alternatively, the communication can be accomplished by using a method of communication specific to the invention. For example, where the embodiment described by FIG. 3 is implemented as a software module, the software module may output the digital message in the pivot language to a second specified software module.

The communication may include additional information, such as the original digital message, the natural language in which the original digital message was composed, the originator's name, the intended recipient, the target natural language, and/or an address of service that can translate the digital message in the pivot language into a digital message in a natural language.

### CREATION OF DIGITAL MESSAGE IN NATURAL LANGUAGE

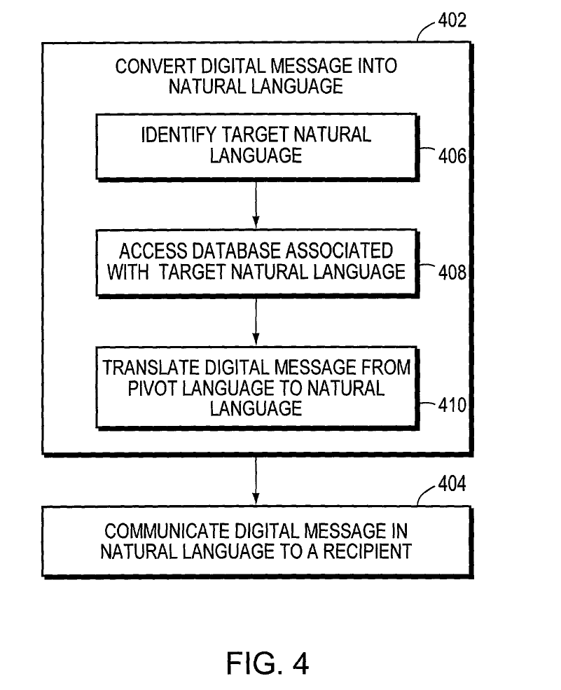

In accordance with an embodiment of the invention, FIG. 4 describes the process of converting a digital message in a pivot language into a target natural language and communicating the resulting digital message to a recipient. The function of the process described by FIG. 4 is to complete the translation of a digital message to a natural language that was facilitated by the process described in FIG. 3.

The first step in the process described by FIG. 4 is to convert a digital message in a pivot language into a digital message in a natural language (STEP 402). Again, the characteristics of the selected pivot language affect the manner in which the conversion is performed, since a digital message in a pivot language can be converted into digital message in a natural language in a variety of ways. In general, STEP 402 is accomplished by performing a series of intermediate steps. In apparatus which implements the process described by FIG. 4, the conversion module may be contained on a single computational processor. Alternatively, the conversion module may comprise several smaller modules each of which perform an intermediate step in the conversion process. These smaller modules may be distributed on multiple computational processors that are connected by a communications system.

The first step in the conversion process is to identify a target natural language to which the digital message in the pivot language should be translated (STEP 406). The target natural language may be attached to the digital message and sent with the digital message. Alternatively, the target natural language may be selected by the recipient of the digital message in the pivot language. It may also be derived from available information on the intended recipient of the digital message. For example, a potential recipient of a digital message that has been converted into a pivot language may register his preferred natural language with a translation service.

The process of identifying a target natural language may include a series of steps, any of which may result in the identification of a target natural language. For example, the process may include checking the digital message for an attachment that identifies the target natural language. If the attachment exists, that target natural language is used. If not, the process may continue by prompting the intended recipient to select a natural language.

The second step in the conversion process is to access a database associated with the target natural language (STEP 408). A single database may exist for a specific natural language. Alternatively, multiple databases may exist for a specific natural language. For example, there may be a standard French database as well as a French biotechnology database. A plurality of databases for a single natural language may also be associated with various specific pivot languages. A database may be a component of the conversion apparatus or, alternatively, access to a separate database may be provided as a separate service. The process for gaining access will vary accordingly.

The third step in the conversion process is to translate the digital message from the pivot language to the target natural language (STEP 410). The proper translation process is dependent on the characteristics of the specific pivot language that is used. The simplest translation can be performed with a pivot language that is based on a constrained vocabulary with an index of unique concepts. In such a case, if the English database contains 100,000 stored concepts, for example, then the French, German and Spanish databases would also each contain 100,000 concepts, each concept linked across languages in a one-to-one correspondence by the index. In such a case, direct substitution of a stored concept from the pivot language to the target natural language is made possible by the index, which may be a keynumber system. In that case, translation may be performed by directly substituting the pivot language concept for the target natural language concept with the same keynumber. Of course, other indices can be used to produce the same result. More sophisticated translation may include reorganizing the sentence structure of the digital message in the pivot language in accordance with grammatical rules associated with the target natural language. The reorganization may be done either before or after a direct substitution of linguistic units. Indeed, reorganization may be an optional part of the translation process.

The second step in the process described by FIG. 4 is to communicate the digital message in a pivot language to a recipient (STEP 404). The communication can be accomplished by taking advantage of an existing method of communication within a specific infrastructure, such as using an existing e-mail system associated with the Internet. Alternatively, the communication can be accomplished by using a method of communication specific to the invention. The communication may include additional information, such as the original digital message, the natural language in which the original digital message was composed, the originator's name, the digital message in a pivot language, the natural language to which the digital message has been converted, and/or an address of service that can translate the digital message in the pivot language into a digital message in a natural language.

### INFRASTRUCTURES

The present invention can be implemented to take advantage of one or more of a variety of existing communication infrastructures. The landline telephone network is a well-known communication infrastructure. That infrastructure has been expanded and continues to expand to accommodate wireless telephonic communication links.

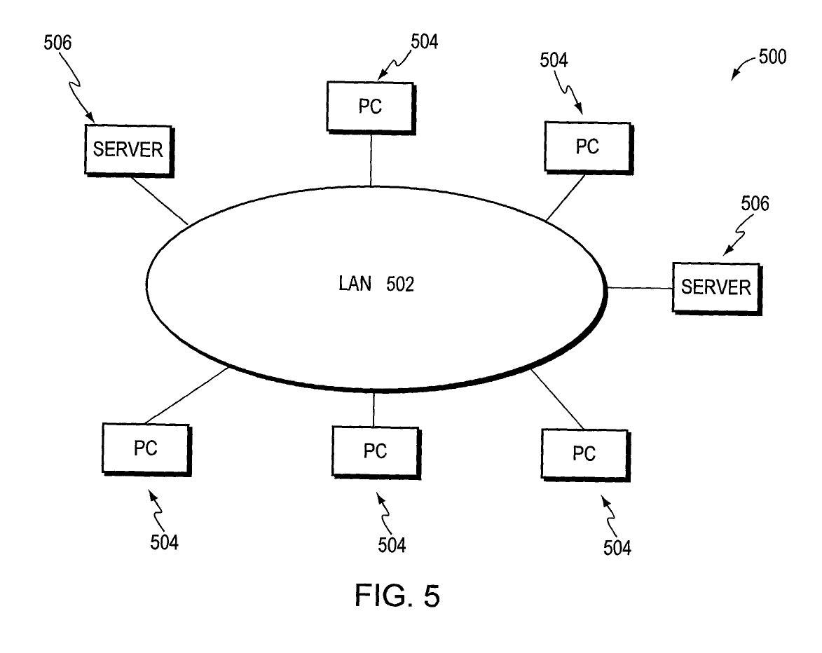

FIG. 5 illustrates a simple network infrastructure 500 organized as a local area network (LAN) 502. This infrastructure is typically found in campuses, small offices and companies, wherein network communication is limited to a certain locality. The personal computers (PCs) 504 are directly connected to the LAN 502 for the interchange of information among each other using a network protocol such as the Token-ring protocol. One or more servers 506 are also connected to the LAN 502 to service the LAN and the PCs.

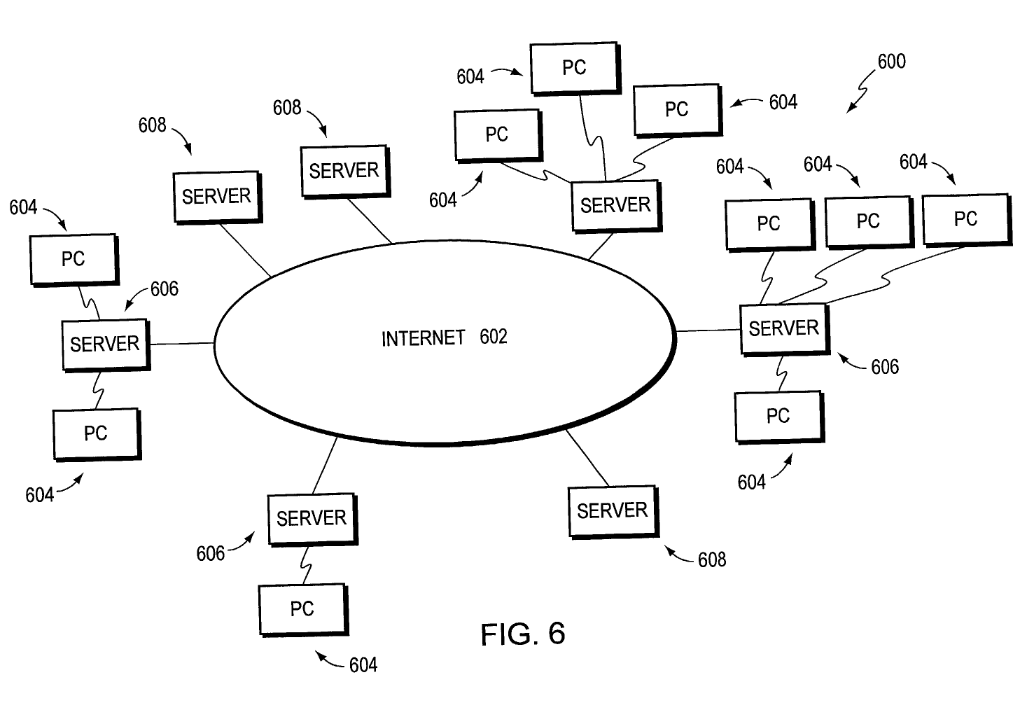

FIG. 6 illustrates a more complex network infrastructure 600 in which the network 602 is a wide area network (WAN) or the Internet. The Internet operates globally and interconnects various servers 606, 608 regardless of their geographical locations. Certain servers 606 act as gateways that allow the PCs 604 to be connected to the Internet (these servers are called Internet Service Providers (ISPs)) while certain servers 608 function as resource servers. Note that the ISP servers can also function as resource servers and vice versa. The World Wide Web (Web) is a subset of the Internet that houses millions of Web pages (which are resources) and can be accessed via Web sites using the Uniform Resource Locators (URLs). A browser locates the resources desired by a user using URLs. A URL includes a domain name that identifies the organization that is providing the resource.

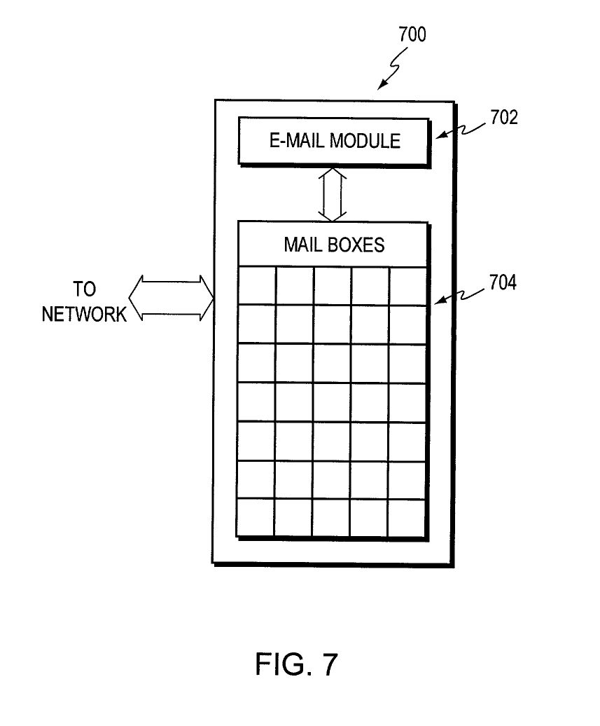

FIG. 7 depicts an e-mail server 700, which may be a server 506 (see FIG. 5), at least one of the servers 606, 608 (see FIG. 6), or any servers configured to provide e-mail service that is accessible by the e-mail users. The entity providing the service may be the organization itself or an outside entity such as an ISP. The e-mail server 700 comprises an e-mail module 702 which may be a processor executing a sequence of instructions that causes the server to receive, store and send e-mail messages and documents. E-mail software is well known and many packages are available commercially. The e-mail server 700 further includes a series of mailboxes 704, each box being assigned to an e-mail recipient; conceptually, this organization is not very different from postal mailboxes found in apartment buildings, for example. When the e-mail server 700 receives an e-mail message, it examines the recipient address included in the e-mail to determine the mailbox in which the e-mail should be stored. In a simpler network, as shown in FIG. 5, the identity of the user may suffice as an e-mail address. In a more complex network, such as the Internet, an e-mail address is a form of URL that includes both the identification of the user and the domain name of the user's e-mail server. Once the message is stored, the e-mail server may wait for recipient access or it may actively seek out the recipient to notify him of the mail. E-mail interface modules located at the PCs make the exchange of e-mails with the e-mail server possible, and are well known in the art.

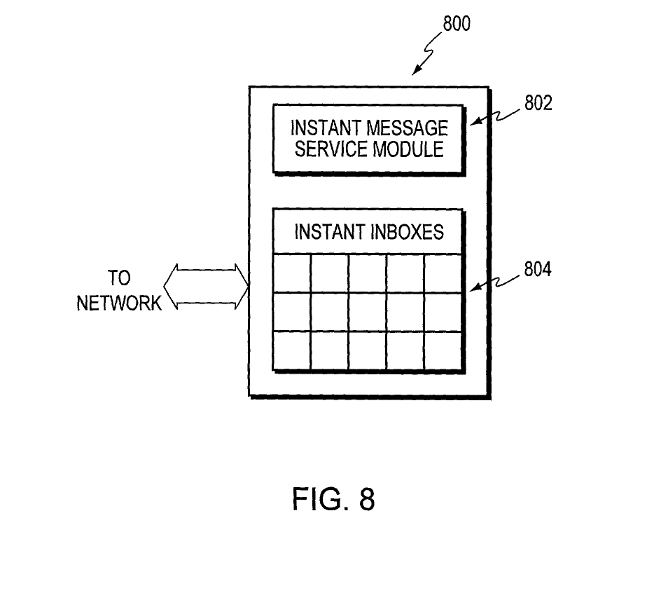

FIG. 8 illustrates an instant message server 800, which may be a server 506 (see FIG. 5), at least one of the servers 606, 608 (see FIG. 6), or any servers configured to provide instant message service that is accessible by the instant message service users. The entity providing the service is typically the organization itself, but may be an outside entity such as an ISP. The instant message server 800 comprises an instant message service module 802 which may be a processor executing a sequence of instructions that causes the server to receive and transmit instant messages. Instant message software is well known and many packages are available commercially. The instant message server 800 further includes instant inboxes 804, each inbox being assigned to an instant message recipient. Conceptually, the organization of an instant message service is similar to an e-mail service. Indeed, an instant message address is similar to an e-mail address. Instant messaging differs from e-mail primarily in that its primary focus is immediate delivery to the recipient. Before an instant message can be sent, a presence service is typically used to determine if the intended recipient is “present” on-line. A presence service may use a fetcher watcher model, which simply requests the current value of a recipient's presence status. A presence service may alternatively use a subscriber watcher model in which requests notification of any changes in presence states. When an instant message server 800 receives an instant message, it examines the recipient address included in the instant message to determine the instant inbox to which the message should be communicated. An instant message may be displayed at the recipient's instant inbox while it is being composed.

### EXEMPLARY E-MAIL IMPLEMENTATIONS

The present invention may be implemented in a commercially available e-mail system using a constrained grammar (lexical rules and/or structured sentences) enforced by an editor. Thus, for example, when text is being written for transmission via e-mail, the text is edited for conformance to the constrained grammar. (Further details of this process will be described in the hardware implementation section.) Once the text conforms to the constrained grammar, it may be transmitted using one or more of the following approaches. These approaches are especially useful in describing the various ways that the process described by FIG. 4 can be implemented.

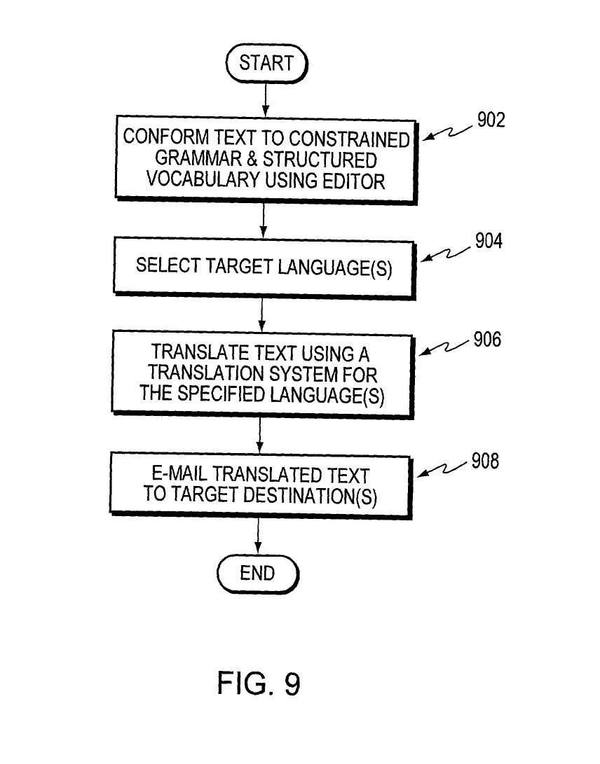

In a first approach, illustrated in FIG. 9, the originator places the text in conformance with the pivot language using the constrained-grammar editor (block 902). This process corresponds to STEP 302 in FIG. 3. Once the editor indicates that the text is in conformance, the originator selects a target language for each recipient (block 904). The e-mail system has module for converting a digital message in a pivot language into a natural language. The module, indicated at 906 and equivalent to STEP 402 of FIG. 4, translates the constrained-grammar text to the specified language(s). Prior to conversion, the digital message is communicated to the conversion module in accordance with STEP 304 in FIG. 3. The translated text is then e-mailed to the target destination(s) specified by the originator (block 908 in FIG. 9, and STEP 404 of FIG. 4).

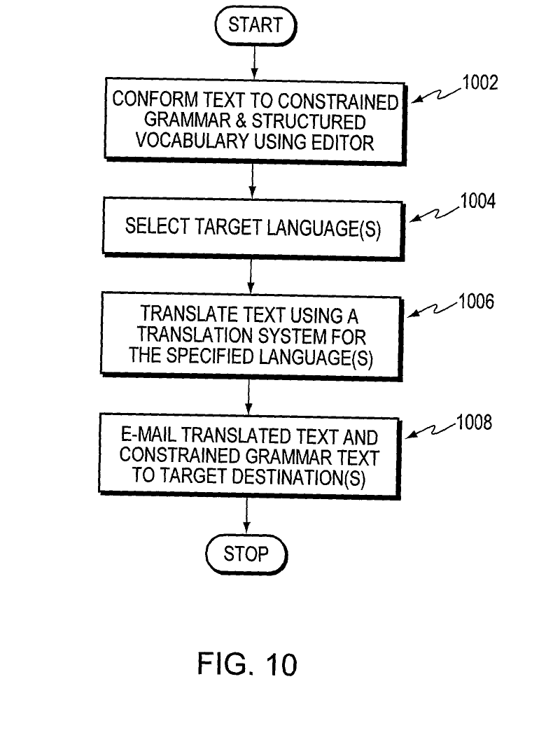

In the alternative shown in FIG. 10, the originator places the text in conformance with the pivot language using an editor (block 1002). Once the editor indicates that the text is in conformance, the originator selects a target language for each recipient (block 1004). The e-mail system has a module for converting a digital message in a pivot language into a natural language, as indicated in block 1006; this system translates the pivot-language text into the specified language(s) (see STEP 402 of FIG. 4). The translated text along with the source (pivot language) text is transmitted to the target destination(s) specified by the originator (block 1008 in FIG. 10, and STEP 404 of FIG. 4). This approach is particularly useful, for instance, where the translated text is converted into a natural language. By preserving the constrained-grammar representation, the recipient is free to further transmit the received text to other destination(s) where it may again be translated.

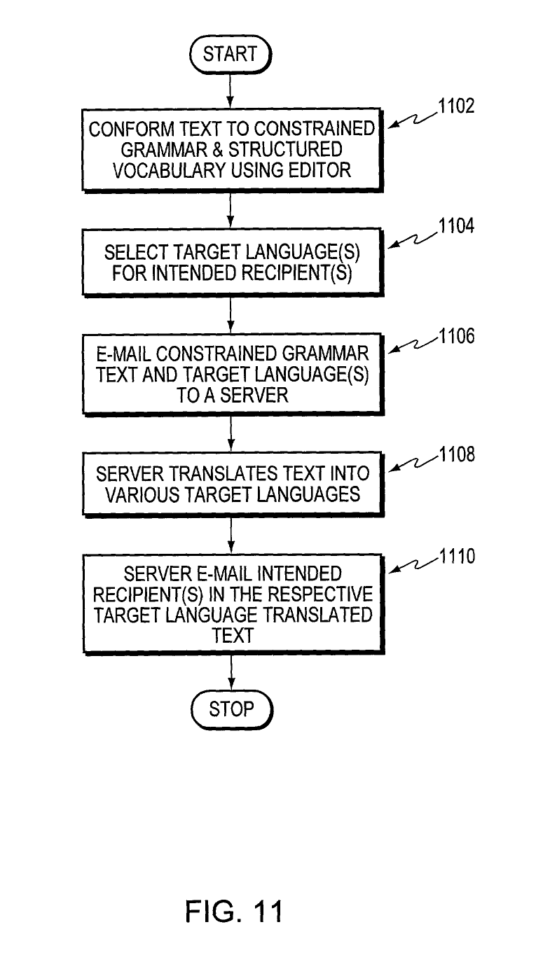

In the implementation shown in FIG. 11, the originator places the text in conformance with the pivot language using an editor (block 1102 in FIG. 11, and STEP 302 of FIG. 3). Once the editor indicates that the text is in conformance, the originator selects a target language for each recipient (block 1104). As indicated in block 1106, the pivot-language text, along with the specified language(s) for the recipient(s), is transmitted to a server for translation (block 1106 in FIG. 11, and STEP 304 in FIG. 3). Thus, the text may be sent to the server via e-mail (in which case the editing facility resides within the sender's e-mail system) or by direct interaction via Web pages, with a Web site server. The server, equipped with a translation system such as the one described above translates the text into the specific language(s) (block 1108 in FIG. 11, and STEP 402 of FIG. 4). Once the text has been translated for all the specified languages, the server sends the translated text to the intended recipient(s) via e-mail (block 1110 in FIG. 11, and STEP 404 in FIG. 4).

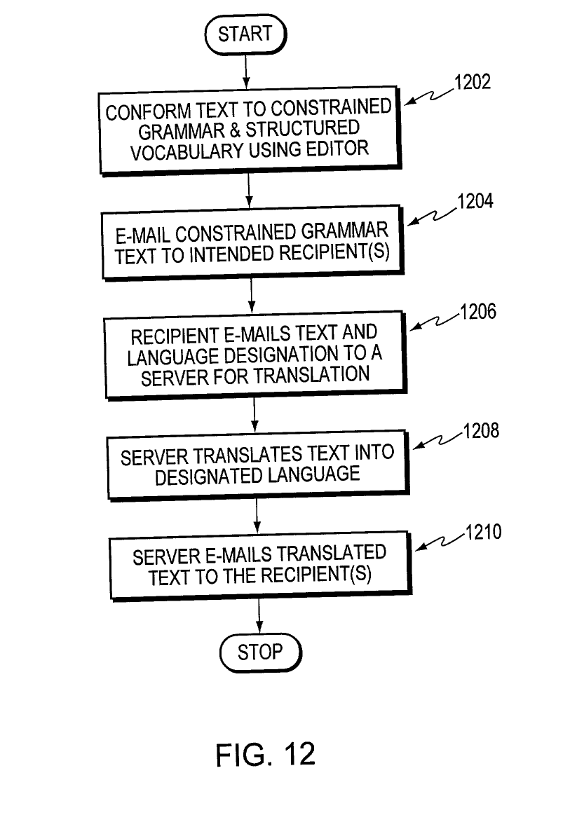

With reference to the implementation illustrated in FIG. 12, the originator places the text in conformance with the pivot language using an editor (block 1202). Once the editor indicates that the text is in conformance (STEP 310 of FIG. 3), the originator sends the text to each of the intended recipient(s) via e-mail (block 1204 in FIG. 12, and STEP 304 in FIG. 3). On receipt of the text, one or more recipients transmit the text and a language designation to a server (which may be a Web site) set up for translation purposes (block 1206). The server, which is equipped with conversion module that implements STEP 402 in FIG. 4, translates the text into the recipient's designated language (block 1208). It should be stressed that the recipient may specify a desired language during an initial set-up session with the server rather than for each message. Once the server has translated the text into the designated language, it sends the translated text to the recipient by e-mail (block 1210 in FIG. 12, and STEP 404 in FIG. 4).

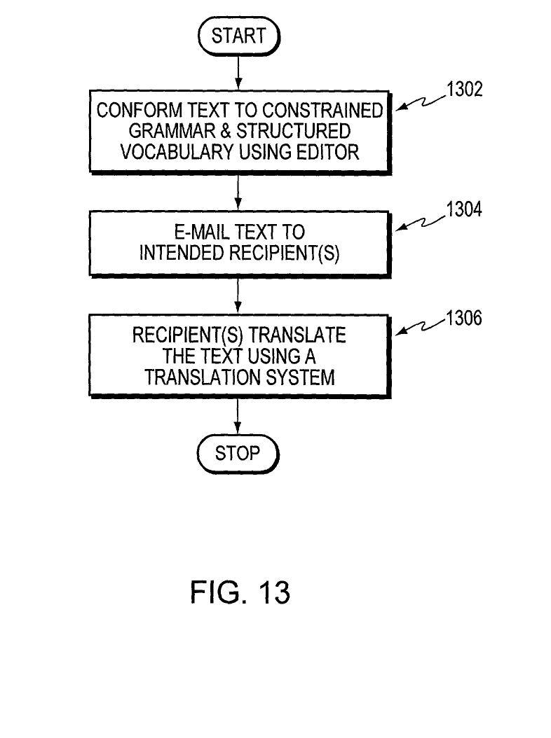

In the implementation shown in FIG. 13, the originator places the text in conformance with the pivot language using an editor (block 1302). Once the editor indicates that the text is in conformance (STEP 310 in FIG. 3), the originator sends the text to one or more recipients via e-mail (block 1304 in FIG. 13, and STEP 304 in FIG. 3). The recipient has in his e-mail system a pivot language conversion module that is able to translate the text into his native language. On receipt of the text, this system is activated (block 1306). The recipient may manually instruct the conversion module to perform the conversion or the conversion module may perform the conversion automatically. In this case, STEP 404 in FIG. 4 might consist of displaying the e-mail in the native language of the recipient.

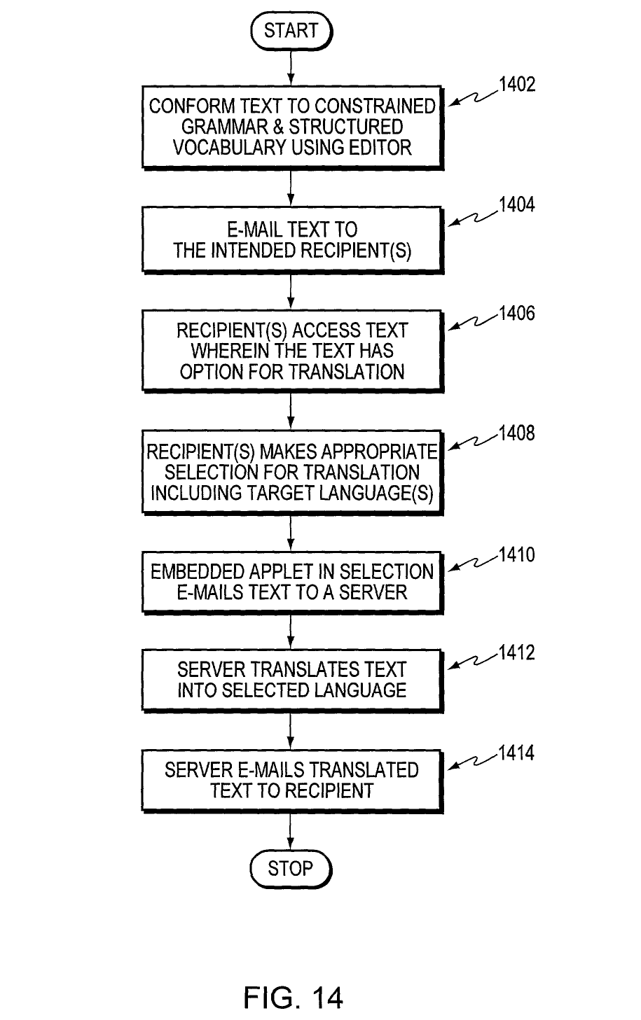

A variation to the foregoing approach is shown in FIG. 14. The originator places the text in conformance with the pivot language using an editor (block 1402). Once the editor indicates that the text conforms, the originator sends it to one or more recipients, who have neither translation capabilities nor contact with a server that has such capabilities, via e-mail (block 1404 in FIG. 14, and STEP 304 in FIG. 3). However, the constrained-grammar text further includes an icon or a message with a select button that indicates that the text can be translated (block 1406). When the recipient selects the icon or the button, a menu appears allowing the recipient to choose a language and to request translation when the latter option is selected (block 1408). The selection activates an embedded applet or script that causes the message to be transmitted to a Web site set up for that purpose (block 1410). The Web site is equipped with a pivot language conversion module, which translates the text to the recipient's selected natural language (block 1412 in FIG. 14, and STEP 402 in FIG. 4). The server of the Web site re-transmits the translated text back to the recipient via e-mail (block 1414 in FIG. 14, and STEP 404 in FIG. 4). This approach is useful, for instance, when translation is tracked or billed on per-use basis.

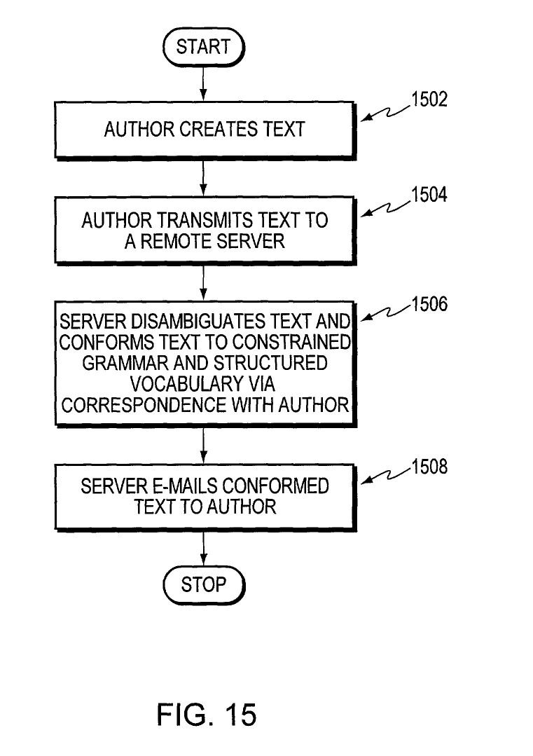

So far, the approaches described above assume that the originator edits text from his PC. However, the editor may reside in a remote server, with which the originator corresponds by transmitting his text to and receiving modified text from the server until the text is in conformance with the pivot language. As shown in FIG. 15, the originator creates a message to be transmitted to recipient(s) (block 1502). The originator may write a complete initial draft of the text prior to disambiguation; or the originator may instead communicate with the server-based editor (e.g., on a sentence-by-sentence basis) as he is creating the text. In the former procedure, once the text is completed, the originator transmits the text to the remote server (block 1504). The server disambiguates the text and places it in conformance with the pivot language (block 1506 in FIG. 15, and STEP 302 in FIG. 3). The server then transmits the text to the originator for his disposal (block 1506 in FIG. 15, and STEP 304 in FIG. 3). In the latter case, communication may take place via successive web pages or by means of an applet.

### EXEMPLARY INSTANT MESSAGE IMPLEMENTATION

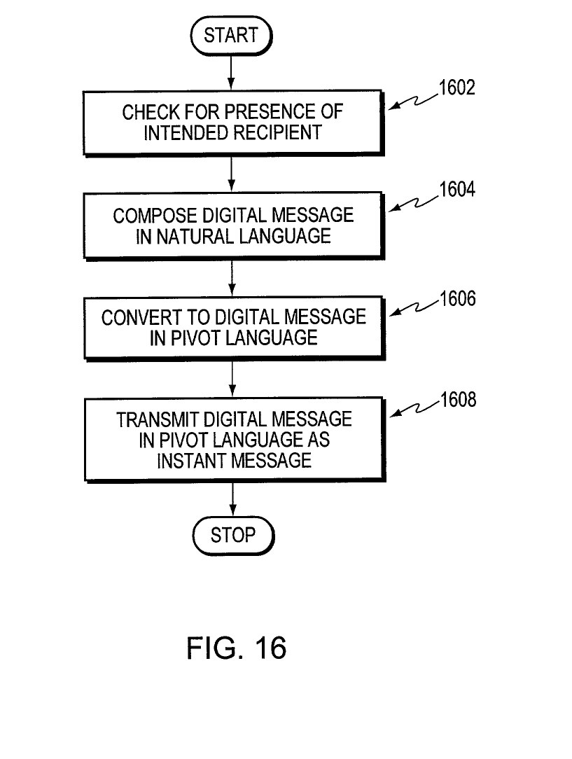

In the implementation shown in FIG. 16, the originator uses a presence service to determine if the intended recipient of an instant message is present on-line (block 1602). Finding the recipient present and knowing that therefore instant messages will be accepted at the instant inbox associated with the recipient, the originator composes a digital message in his natural language to transmit as an instant message (block 1604). Upon completing of the message, the originator activates the module that converts a digital message in a natural language to a digital message in a pivot language (block 1606 in FIG. 16, and STEP 302 in FIG. 3). The module may be an add on to an existing instant messaging service and may have a user interface similar to a conventional spelling checker. The conversion module accepts the digital message in the natural language as input, immediately parsing it into linguistic units (STEP 306 in FIG. 3). The conversion module analyses the parsed digital message and searches a database for pivot language equivalents for the linguistic units, making appropriate substitutions (STEP 308 in FIG. 3). When the conversion module locates a set of linguistic units that may translate to more than one unique concept in the pivot language database, it presents the originator with the selection. The originator chooses the proper translation and the conversion module continues the translation process. Either during the translation process or upon its completion, the conversion module checks the digital message to determine if it complies with the rules of the pivot language (STEP 310 in FIG. 3). It signals the originator when the digital message conforms to the rules of the pivot language. The originator then addresses the digital message to the instant inbox of the intended recipient and transmits it to the instant message service for delivery (block 1608 in FIG. 16, and STEP 304 in FIG. 3). The intended recipient will almost immediately receive the instant message in the pivot language, whereupon he can activate a module that converts a digital message in a pivot language to a digital message in a natural language.

### EXEMPLARY VOICE IMPLEMENTATIONS

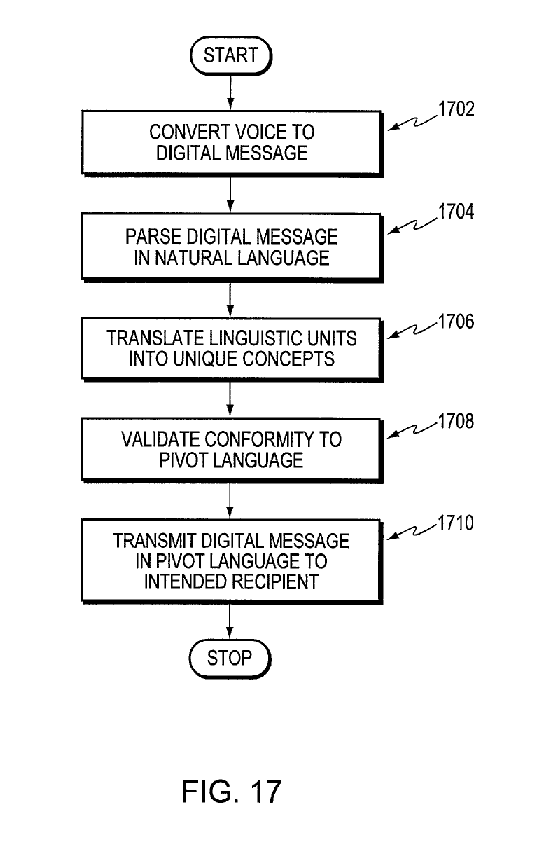

In the implementation shown in FIG. 17, a speaker uses speech recognition apparatus to convert the sound of his voice into a digital message in a natural language (1702). The digital message in the natural language is communicated to a conversion module that converts it into a digital message in a pivot language. The conversion module parses the digital message as it is received (block 1704 in FIG. 17, and STEP 306 in FIG. 3). The conversion module can interact with the speaker to disambiguate the message as it is converted into the pivot language (block 1706 in FIG. 17, and STEP 308 in FIG. 3). For example, during the pause that indicates the end of one of the speaker's sentences, the conversion module can prompt the speaker to select his intended meaning ambiguous terms, providing choices corresponding to possible meanings. In one implementation, the conversion module uses conventional speech synthesis apparatus to communicate the choices to the speaker. The speaker can then verbally select among the choices to specify his intended meaning. Alternatively, the speaker can designate the proper choice by acting in accordance with a specified response technique, such as saying “one” for the first choice or “two” for the second choice. After the initial disambiguation, further analysis may be performed by the conversion module to verify the compliance of the digital message with the rules of the pivot language (block 1708 in FIG. 17, and STEP 310 in FIG. 3). Once the digital message conforms to the rules of the pivot language, the conversion module may report the completion of the conversion process to the speaker. The speaker can then confirm that the message should be sent to its intended recipient. Alternatively, the digital message in the pivot language can be sent automatically to its designated recipient upon completion of the conversion process (block 1710 in FIG. 17, and STEP 304 in FIG. 3).

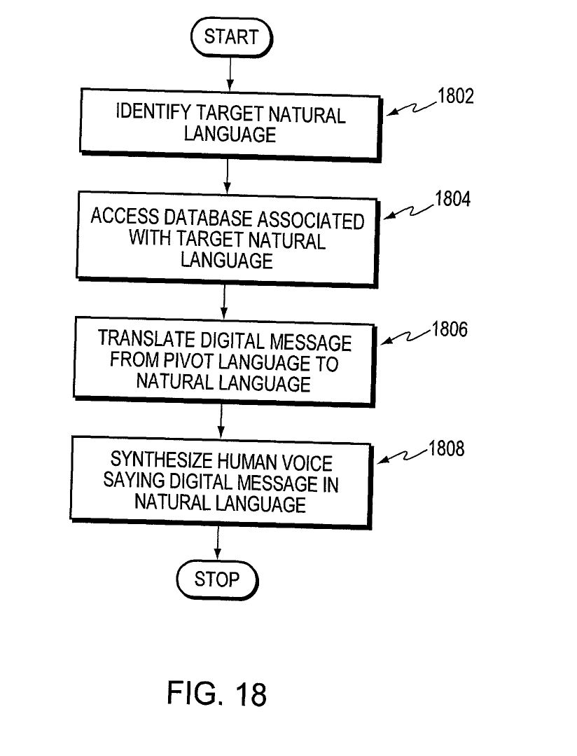

In the implementation shown in FIG. 18, the recipient of a digital message in a pivot language wishes to hear the digital message in his preferred natural language. Accordingly, the digital message in the pivot language serves as input to a conversion module that converts from pivot language to natural language. The conversion module identifies the target natural language, by either accessing the recipient's preferred natural language in memory or prompting the recipient to select a natural language (block 1802 in FIG. 18, and STEP 406 in FIG. 4). The conversion module then accesses a database associated with the target natural language (block 1804 in FIG. 18, and STEP 408 in FIG. 4) and translates the digital message into the target natural language (block 1806 in FIG. 18, and STEP 410 in FIG. 4). Once the conversion is complete, the recipient may be prompted to select the form in which he wants the digital message in the natural language to be communicated to him. The recipient may alternatively be prompted earlier in the process. In another alternative, the recipient's preference may be retrieved from memory. When the recipient selects aural communication, speech synthesis apparatus is used to synthesize the sound of a human voice saying the digital message in the natural language (block 1808 in FIG. 18, and STEP 410 in FIG. 4).

When used in conjunction with the implementation of FIG. 17, the implementation described by FIG. 18 may be the fastest and most natural approach to facilitating communication in a business meeting, in which the participants do not share knowledge of the same natural language. In such a scenario, block 1710 in FIG. 17 may be accomplished by communication the digital message in the pivot language to the other meeting participant as an instant message.

### EXEMPLARY HARDWARE IMPLEMENTATION OF FIG. 3 PROCESS

A representative hardware implementation of the FIG. 3 process includes multiple logically or physically distinct electronic databases of vocabulary (including the various concepts associated with word-concepts and phrases); a computer memory partition for accepting an input in a reference language; an editor (generally a processor operated in accordance with stored computer instructions) for monitoring the reference language with a set of tools that facilitates disambiguation of the reference language; and an e-mail package that provides conventional e-mail transmission and receipt services through a communication module.

The hardware described above may be part of a user system, or at least portions thereof may be remote from the user system and accessible to the user via a user interface. The user interface may be a remote terminal, a computer (a desktop or a portable) adapted for communication with a network such as the Internet, a telecommunication device such as a cellular phone with alphanumeric keypad and display, or the like. Instead of including language monitoring and disambiguation tools itself, the editor may alternatively interact (e.g., via the network) with one or more modules that perform those functions. Further, the e-mail package could be replaced with another message transmission modality, such as an instant message service package that provides conventional instant messaging service and presence service through a communication module.

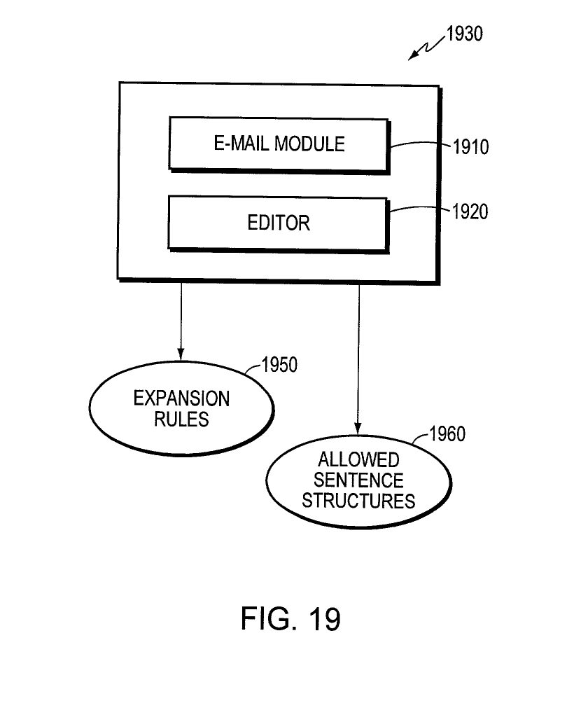

With reference to FIG. 19, the e-mail module 1910 and the editor 1920 may be implemented as instructions stored on a computer-readable medium 1930. Editor 1920 includes a plurality of tools including a conventional parsing tool (see STEP 306 in FIG. 3), a word-concept disambiguation tool, a phrase disambiguation tool and a sentence disambiguation tool (see STEP 308 in FIG. 3). The medium 1930 is coupled to a database 1950 of expansion rules on which it relies during disambiguation of text. The medium 1930 is also coupled to a database 1960 of allowed sentence structures to further the disambiguation process. The e-mail module and the editor may be stored in a memory (as discussed below) until portions thereof are fetched by the processor. Alternatively, the e-mail interface module and the editor may be in hardware form such as an application-specific integrated circuit (ASIC) or in a nonvolatile memory such as a Flash memory.

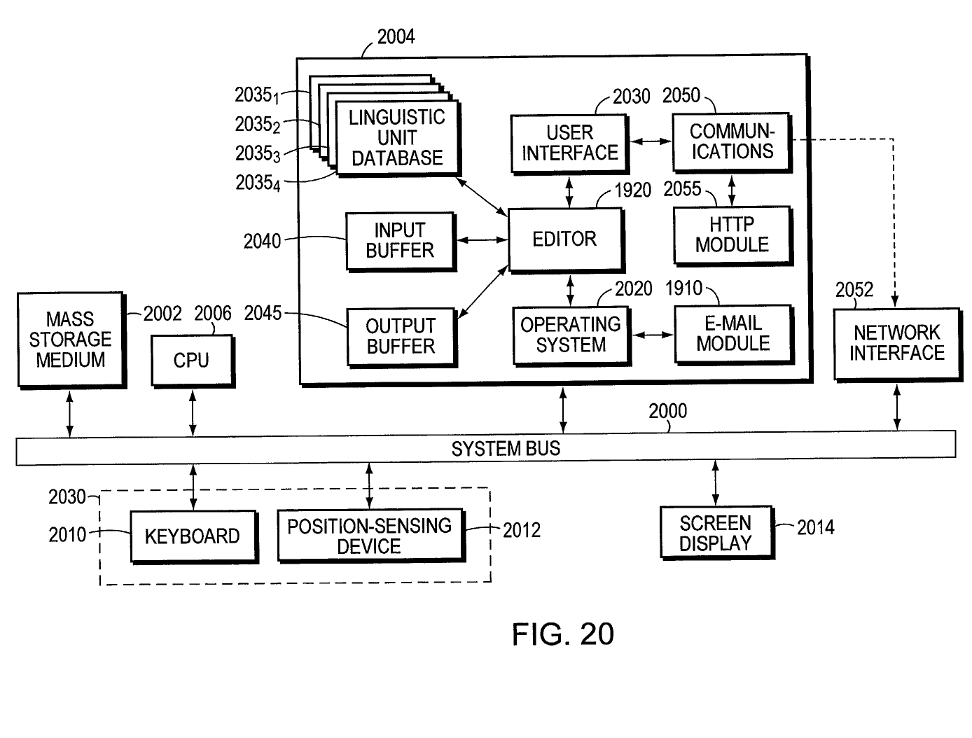

With reference to FIG. 20, an exemplary hardware implementation includes a main bi-directional bus 2000, over which all system components communicate. The main sequence of instructions effectuating the invention, as well as the databases discussed below, resides on a mass storage medium (such as a hard disk, or a magnetic or an optical disk) 2002 as well as in a main system memory 2004 during operation. Execution of these instructions and effectuation of the functions of the invention is accomplished by a central-processing unit (“CPU”) 2006.

The user interacts with the system by means of a user interface 2030 using a keyboard 2010 and/or a position-sensing device (e.g., a mouse) 2012 connected to the system. The output of either device can be used to designate information or select particular areas of a screen display 2014 to direct functions to be performed by the system. Remote communication may be established using conventional communication interfaces (e.g., a network interface 2052).

The main memory 2004 contains a group of modules that control the operation of CPU 2006 and its interaction with the other hardware components. An operating system 2020 directs the execution of low-level, basic system functions such as memory allocation, file management and operation of mass storage devices 2002. As previously described, the editor 1920 implements and directs execution of the primary functions of the invention. Specifically, the editor monitors word-concepts, phrases and sentences for ambiguity in a text. Interaction with editor 1920, as well as provision of user text input, is facilitated by the user interface 2030. The user interface 2030 and editor 1920 generate word-concepts or graphical images on display 2014 to prompt action by the user, accepting user commands from keyboard 2010 and/or position-sensing device 2012.

Main memory 2004 also includes a partition defining a series of databases capable of storing the linguistic units of the invention, and representatively denoted by reference numerals 2035₁, 2035₂, 2035₃, 2035₄. The databases 2035, which may be physically distinct (i.e., stored in different memory partitions and as separate files on storage device 2002) or logically distinct (i.e., stored in a single memory partition as a structured list that may be addressed as a plurality of databases), each contain all of the linguistic units corresponding to a particular class. Each database may be organized as a table whose columns lists all of the linguistic units of a particular class in the source language with an index, which can be used to correlate each linguistic unit to an equivalent linguistic unit expressed in a different natural language. In one implementation, the table includes the equivalent linguistic units in various different natural languages. In a second implementation, the table includes only the index and the linguistic units in the source language. In the illustrated implementation, nominal terms are contained in database 2035₁, connectors are contained in database 2035₂, descriptors are contained in database 2035₃, and logical connectors are contained in database 2035₄

As shown in FIG. 2, a database structure 200 may comprise a plurality of fields for each linguistic unit. A first field 202 may contain an index, such as a unique keynumber; a second field 204 may be contain a concept. Another field 206 may contain a class or subclass associated with the linguistic unit. Alternatively, the keynumbers may be categorized and used to identify classes or sub-classes. Another field (not shown) may place the linguistic unit in a domain or in a category. In one embodiment, the concept field may contain a pointer to another linguistic unit. For instance, the linguistic unit may have a word-concept “take” in the word-concept field and an instruction “goto keynumber #1234” in the concept field, which points to another linguistic unit identified by the keynumber #1234. The pointed linguistic unit may have a word-concept entry “steal” and a concept “to steal something from someone.” The word-concept “take” is then associated with the above concept and synonymous with the word-concept “steal.”

An editor 1920 using the above database structure 200 may operate as follows. Once the editor detects a word-concept in a text (STEP 306 in FIG. 3), the word-concept is matched with the linguistic units in the database. Specifically, the detected word-concept is matched with a word-concept linguistic unit or a word-concept that forms a component of a larger linguistic unit. For example, if the editor detects “resident”, it searches the database and may find “resident” and “medical-resident.” The editor may then retrieve the two word-concepts and prompt the originator for clarification. If a field of the linguistic unit indicates that a medical domain is preferred, the editor may highlight “medical-resident” as a preferential choice. In instances where the class of the word-concept is known, the editor may search only that particular class. The class may be ascertained, for example, through the finite set of the constrained grammar rules or allowed sentence structures. Alternatively, in instances where the class of the word-concept is known, the editor may present to the originator as choices only those linguistic units that are in the proper class. The above examples illustrate how the editor may perform disambiguation in conjunction with the linguistic units.

An input buffer 2040 receives from the user, via keyboard 2010, input sentences in a pivot language (e.g., in accordance with the constrained grammar as described in the '247 patent or the '515 application). Editor 1920 enforces the rules of the pivot language as the user enters text, or may instead analyze text after it has been completely entered.

Once an entire digital messages is disambiguated and in conformance with the pivot language (STEP 310 in FIG. 3), the digital message is communicated to the intended recipient (STEP 304 in FIG. 3). In a system that includes elements which implements both the process illustrated in FIG. 3 and the process illustrated in FIG. 4, the intended recipient will be the conversion module that implements STEP 402 in FIG. 4.

As described above, the present invention includes an e-mail module 1910 that communicates over a computer network. A network communication block 2050 provides programming to connect with a computer network, which may be a local-area network, a wide-area network, or the Internet. Communication module 2050 drives network interface 2052, which contains data-transmission circuitry to transfer streams of digitally encoded data over the communication lines defining the computer network.

Memory 2004 may also contain modules that confer the capability of communicating over the Web. It is known in the art that communication over the Internet is accomplished by encoding information to be transferred into data packets, each addressed with a destination according to a consistent protocol. Groups of packets are reassembled upon receipt by the target computer. Common protocols for this purpose are the Internet Protocol (IP), which dictates routing information, and the transmission control protocol (TCP), which dictates how messages are broken up into packets for transmission, subsequent collection, and reassembly.

In the case of Internet connections, data exchange is typically effected over the web by means of web pages. In this case storage device 2002 contains a series of web page templates, which comprise formatting (mark-up) instructions and associated data, and/or so-called “applet” instructions that cause a properly equipped remote computer to present a dynamic display. Management and transmission of a selected web page is handled by a web server module 2055, which allows the system to function as a web (http) server.

The markup instructions are executed by an Internet “browser” running a remote computer that has accessed the illustrated system via the web. These markup instructions determine the appearance of the web page on the browser; in effect, the web pages serve as the user interface for the remote computer. Web server 2055 transfers user-supplied sentences to editor 1920, which reviews them and communicates as necessary with the remote user via appropriately formatted web pages transmitted back to the user by server 2055.

### EXEMPLARY HARDWARE IMPLEMENTATION OF FIG. 4 PROCESS

A representative hardware implementation of the FIG. 4 process includes multiple logically or physically distinct electronic databases of vocabulary (including the various concepts associated with word-concepts and phrases); a conversion module for converting a digital message in a pivot language into a target natural language; and a computer memory partition for accepting a digital message in a pivot language as input.

The above-described hardware may be part of a user system, or at least portions thereof may be remote from the user system and accessible to the user via a user interface. The user interface may be a remote terminal, a computer (a desktop or a portable) adapted for network such as the Internet, a telecommunication device such as a cellular phone with alphanumeric keypad and display, and the like.

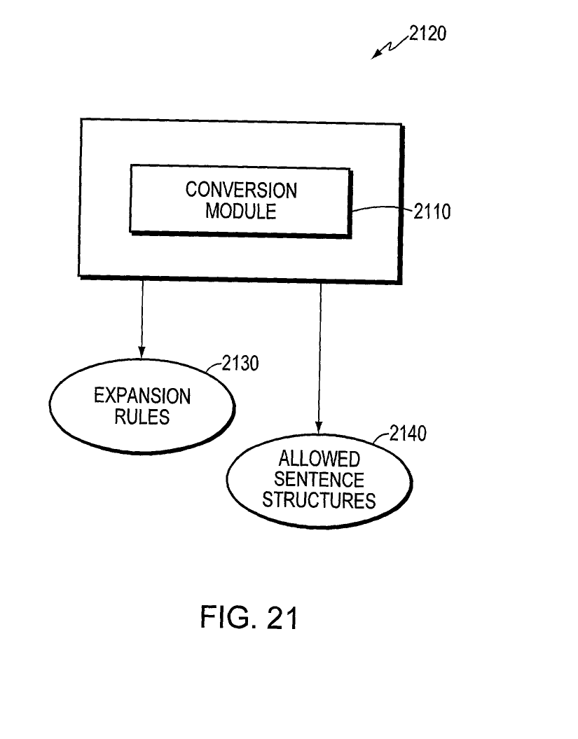

With reference to FIG. 21, the conversion module 2110 may be implemented as instructions stored on a computer-readable medium 2120. The medium 2120 is coupled to a database 2130 of expansion rules for different natural languages on which it relies during conversion of the digital message to a target natural language. The medium 2120 is also coupled to a database 2140 of allowed sentence structures for different natural languages. The conversion module may be stored in a memory (as discussed below) until portions thereof are fetched by the processor. Alternatively, the conversion module may be in hardware form such as an application-specific integrated circuit (ASIC) or in a nonvolatile memory such as a Flash memory.

Conversion of a digital message in a pivot language to a digital message in a natural language is straightforward because the pivot language facilitates translation. Assuming the digital message that is input conforms to the pivot language described in the implementation described by FIG. 2, the keynumber associated with each pivot language concept can be used as an index to linguistic units of a database that holds the word-concepts of another language or languages. In conjunction with the identification of the target natural language, the keynumbers facilitate direct substitution of concepts from the pivot language to the natural language. The allowed sentence structures and expansion rules ensure that the concepts are arranged into sentences that conform to the sentence structure allowed by the target natural language.

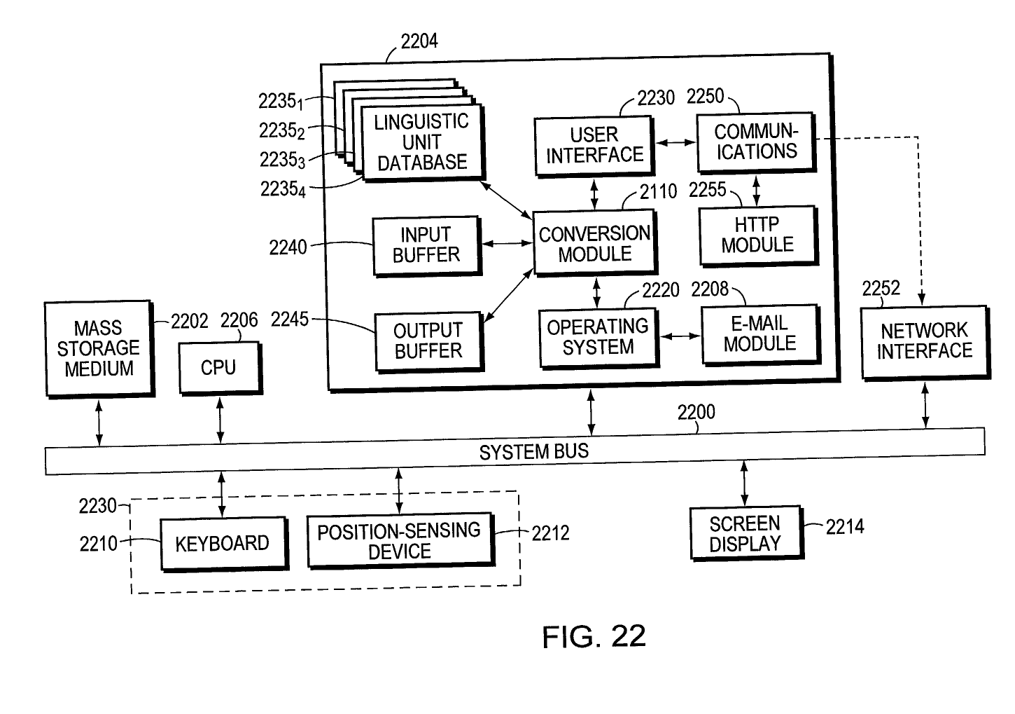

With reference to FIG. 22, an exemplary hardware implementation includes a main bi-directional bus 2200, over which all system components communicate. The main sequence of instructions effectuating the invention, as well as the databases, resides on a mass storage medium (such as a hard disk, or a magnetic or an optical disk) 2202 as well as in a main system memory 2204 during operation. Execution of these instructions and effectuation of the functions of the invention is accomplished by a central-processing unit (“CPU”) 2206.

The user interacts with the system by means of a user interface 2230 using a keyboard 2210 and/or a position-sensing device (e.g., a mouse) 2212 connected to the system. The output of either device can be used to designate information or select particular areas of a screen display 2214 to direct functions to be performed by the system. Remote communication may be established using conventional communication interfaces (e.g., a network interface 2252).

The main memory 2004 contains a group of modules that control the operation of CPU 2206 and its interaction with the other hardware components. An operating system 2220 directs the execution of low-level, basic system functions such as memory allocation, file management and operation of mass storage devices 2202. Interaction with conversion module 2110 is facilitated by the user interface 2230.

Main memory 2204 also includes a partition defining a series of databases capable of storing the linguistic units of the invention, and representatively denoted by reference numerals 2235₁, 2235₂, 2235₃, 2235₄. The databases 2235, which may be physically distinct (i.e., stored in different memory partitions and as separate files on storage device 2002) or logically distinct (i.e., stored in a single memory partition as a structured list that may be addressed as a plurality of databases), each contain all of the linguistic units corresponding to a particular class. Each database may be organized as a table whose columns lists all of the linguistic units of a particular class in a language, and whose rows each contain the same linguistic unit expressed in the different languages that the system is capable of translating. An index to the linguistic units can facilitate translation from a source language to any other language that the system is capable of translating. In the illustrated implementation, nominal terms are contained in database 2235₁, connectors are contained in database 2235₂, descriptors are contained in database 2235₃, and logical connectors are contained in database 2235₄

As shown in FIG. 2, a database structure 200 may comprise a plurality of fields for each linguistic unit. A first field 202 may contain an index, such as a unique keynumber; a second field 204 may be contain a concept. In the context of a translation system, one or more fields 208, 212, 214 may contain a word-concept in a natural language associated with the concept. Another field 206 may contain a class or subclass associated with the linguistic unit. Alternatively, the keynumbers may be categorized and used to identify classes or sub-classes. Another field (not shown) may place the linguistic unit in a domain or in a category. In one embodiment, the concept field may contain a pointer to another linguistic unit.

An input buffer 2240 associated with the conversion module 2110 receives a digital message in a pivot language. The present invention may interact with an e-mail module 2208 that communicates over a computer network. The interaction may occur automatically when a user receives an e-mail in a pivot language with an indicator that translation will be necessary. Alternatively, the user may review an e-mail that has been received, determine that translation is necessary, and transfer it to the input buffer of the conversion module. In yet another alternative, the user may create an e-mail and transfer it to the input buffer of the conversion module for translation to a different natural language prior to sending. In the last case, the user might use the previously described hardware implementation to create the digital message in a pivot language.

A network communication block 2250 provides programming to connect with a computer network, which may be a local-area network, a wide-area network, or the Internet. Communication module 2250 drives network interface 2252, which contains data-transmission circuitry to transfer streams of digitally encoded data over the communication lines defining the computer network.

Memory 2204 may also contain modules that confer the capability of communicating over the Web. The present invention may receive a digital message in a pivot language via the Internet or similar communication network. Web server 2255 may transfer the digital message in a pivot language to the input buffer 2240 of the conversion module 2110, which converts it to a target natural language and communicates the digital message in the natural language to the output buffer 2245. From there, the digital message may then be communicated back to the to the remote user via appropriately formatted web pages transmitted back to the user by server 2255.

It will therefore be seen that the foregoing represents a convenient and fast approach to facilitating the translation of a digital message from a natural language, and to translating a digital message to one or more target natural languages within a communication network. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed. For example, the various modules of the invention can be implemented on a portable general-purpose computer using appropriate software instructions, or as hardware circuits, or as mixed hardware-software combinations.

What is claimed is:

1. A method of facilitating the translation of a digital message between natural languages, the method comprising the steps of:
a. converting a digital message in a natural language to a digital message in a pivot language, the pivot language affording translation into a plurality of natural languages by direct substitution of linguistic units, the converting comprising:
i. parsing the digital message in the natural language into a plurality of linguistic units to create a parsed message;
ii. translating each of the plurality of linguistic units in the parsed message into a unique concept in the pivot language to create a provisional message; and
iii. validating the provisional message as the digital message in the pivot language if the provisional message conforms to the pivot language; and
b. communicating the digital message in the pivot language to a recipient.

2. The method of claim 1, the converting step further comprising resolving the provisional message according to a plurality of rules of a constrained grammar.

3. The method of claim 1, the converting step further comprising prompting selection of a unique concept from the pivot language when the linguistic unit is associated with a plurality of unique concepts in the pivot language.

4. The method of claim 1 wherein the digital message in the pivot language is an instant message and the recipient is an instant message service.

5. The method of claim 1 wherein the digital message in the pivot language is a piece of electronic mail and the recipient is an electronic mail server.

6. The method of claim 1 wherein the recipient is a translation module.

7. The method of claim 1, the method further comprising converting the sound of a human voice into a digital message in a natural language.

8. The method of claim 1, the method further comprising prompting selection of pre-process or post-process disambiguation.

9. The method of claim 1, the method further comprising communicating an applet that initiates translation to the recipient with the digital message in the pivot language.

10. The method of claim 1 wherein the communicating step comprises communicating the digital message in the pivot language to a first recipient, the method further comprising:
c. converting the digital message in the pivot language into a digital message in a second natural language, the converting comprising:
i. identifying the second natural language associated with a second recipient;
ii. accessing a database associated with the second natural language; and
iii. translating the digital message in the pivot language into the digital message in the second natural language using the database; and
d. communicating the digital message in the second natural language to the second recipient.

11. The method of claim 10 wherein the first recipient is the second recipient.

12. An apparatus for facilitating the translation of a digital message between natural languages, the apparatus comprising:
a conversion module, the conversion module converting a digital message in a natural language into a digital message in a pivot language, the pivot language affording translation into a plurality of natural languages by direct substitution of linguistic units, the conversion module comprising:
a parsing module, the parsing module parsing the digital message in the natural language into a plurality of linguistic units;
a translation module, the translation module accessing a database to translate each of the plurality of linguistic units into a unique concept in the pivot language by direct substitution to create a provisional message; and
a validation module, the validation module validating the provisional message as the digital message in a pivot language if the provisional message conforms to the pivot language; and
a communication device, the communication device communicating the digital message in the pivot language to a recipient.

13. The apparatus of claim 12 wherein the conversion module further comprises:
a grammar module, the grammar module resolving the plurality of linguistic units in the provisional message into conformity with a plurality of rules of a constrained grammar.

14. The apparatus of claim 12 wherein the conversion module further comprises:
a disambiguation module, the disambiguation module prompting selection of a unique concept from the pivot language when the linguistic unit is associated with a plurality of unique concepts in the pivot language.

15. The apparatus of claim 12 wherein the digital message in the pivot language is an instant message and the recipient is an instant message service.

16. The apparatus of claim 12 wherein the digital message in the pivot language is a piece of electronic mail and the recipient is an electronic mail server.

17. The apparatus of claim 12 wherein the recipient is a translation module.

18. The apparatus of claim 12 further comprising:
a speech recognition module, the speech recognition module converting the sound

19. The apparatus of claim 12 wherein the conversion module prompts selection of pre-process or post-process disambiguation.

20. The apparatus of claim 12 further comprising:
an applet association module, the applet association module optionally associating an applet that initiates translation with the digital message in the pivot language.

21. The apparatus of claim 12 wherein the communication device is a first communication device, the first communication device communicating the digital message in the pivot language to a first recipient, the method further comprising:
a second conversion module, the second conversion module being responsive to a second natural language associated with a second recipient and converting the digital message in the pivot language into a digital message in a second natural language, the second conversion module comprising:
a database accessor, the database accessor accessing a database associated with the second natural language; and
a translation module, the translation module translating the digital message in the pivot language into the digital message in the second natural language using the database accessor; and
a second communication device, the second communication device communicating the digital message in the second natural language to the second recipient.

22. The apparatus of claim 21 wherein the first recipient is the second recipient.

23. The apparatus of claim 21 wherein the first communication device is the second communication device.

24. A method of translating a digital message into a natural language, the method comprising the steps of:
a. converting a digital message in a pivot language into a digital message in a natural language, the pivot language affording translation into a plurality of natural languages by direct substitution of linguistic units, the converting comprising:
i. identifying a natural language associated with a recipient;
ii. accessing a database associated with a natural language; and
iii. translating the digital message in the pivot language into the digital message in the natural language using the database; and
b. communicating the digital message in the natural language to the recipient.

25. The method of claim 24 further comprising the step of:
receiving a selection of a natural language to associate with the recipient.

26. The method of claim 24 wherein the digital message in the natural language is an instant message and the recipient is an instant message service.

27. The method of claim 24 wherein the digital message in the natural language is a piece of electronic mail and the recipient is an electronic mail server.

28. The method of claim 24 further comprising the step of:
directly substituting a linguistic unit in the digital message in the pivot language with an equivalent linguistic unit from the database associated with the natural language.

29. The method of claim 24 further comprising the step of:
reorganizing the linguistic units in accordance with a grammatical rule associated with the natural language.

30. The method of claim 24, the method further comprising the step of:
synthesizing the sound of a human voice saying the digital message in the natural language.

31. The method of claim 24, the method further comprising the step of causing a serving to receive a digital message in a pivot language, and wherein the converting step further comprises causing the server to convert the digital message in the pivot language into a digital message in a natural language.

32. The method of claim 24 wherein the communicating step is performed in a mode of communication associated with the recipient.

33. The method of claim 24 wherein the converting step is responsive to the execution of an applet.

34. An apparatus for translating a digital message into a natural language, the apparatus comprising:
a conversion module, the conversion module being responsive to a natural language associated with a recipient and converting a digital message in a pivot language into a digital message in the natural language, the conversion module comprising:
a database accessor, the database accessor accessing a database associated with the natural language; and
a translation module, the translation module translating the digital message in the pivot language into the digital message in the natural language using the database accessor; and
a communication device, the communication device communicating the digital message in the natural language to the recipient.

35. The apparatus of claim 34 further comprising:
an index, the index enabling a linguistic unit representing a unique concept in the natural language to be directly substituted for a linguistic unit representing a unique concept in the pivot language.

36. The apparatus of claim 34 wherein the digital message in the natural language is an instant message and the recipient is an instant message service.

37. The apparatus of claim 34 wherein the digital message in the natural language is a piece of electronic mail and the recipient is an electronic mail server.

38. The apparatus of claim 34 wherein the translation module translates the digital message in the pivot language by directly substituting a linguistic unit in the pivot language with an equivalent linguistic unit in the natural language from the database.

39. The apparatus of claim 34 wherein the translation module reorganizes a plurality of linguistic units in the digital message in the pivot language in accordance with a grammatical rule associated with the natural language.

40. The apparatus of claim 34 further comprising:
a voice synthesis module, the voice synthesis module synthesizing the sound of a human voice saying the digital message in the natural language.

41. The apparatus of claim 34 further comprising:
a server accessor, the server accessor transmitting the digital message in the pivot language to a server for conversion into the digital message in the natural language.

42. The apparatus of claim 34 wherein the communication device communicates the digital message in the natural language to the recipient in a mode of communication associated with the recipient.

43. The apparatus of claim 34 wherein the conversion module is responsive to the execution of an applet.
